(19) United States
(12) Patent Application Publication
(10) Pub. No.: US 2005/0193531 A1
(43) Pub. Date: Sep. 8, 2005

(54) Snap hook having lockable pivotal gate

(76) Inventor: Vincent Chang, Taichung (TW)

Correspondence Address: Charles E. Baxley, ESQ., 90 John Street, 3rd Floor, New York, NY, 10038, US

(21) Appl. No.: 10/793,292

(22) Filed: Mar. 2, 2004

(51) Int. Cl. F16B 45/02

(52) U.S. Cl. 24/600.2

(57) ABSTRACT

A snap hook includes a hook member having a mouth formed between two ends, a gate pivotally secured to one end of the hook member and having the other end rotatable toward or away from the hook member to enclose or open the mouth of the hook member. A spring may bias the gate to enclose the mouth of the hook member. A latch is slidably attached onto the gate and may selectively engage with the hook member, to lock the gate to the hook member, and to prevent the other end of the gate from being rotated away from the hook member and thus to prevent the mouth of the hook member from being opened inadvertently, by such as children.

### BACKGROUND OF THE INVENTION

1. Field of the Invention

The present invention relates to a snap hook, and more particularly to a snap hook having a pivotal gate that may be locked to the snap hook and to be prevented from being opened inadvertently.

2. Description of the Prior Art

Typical snap hooks comprise a hook body including a mouth formed or defined between two ends, and a latch or gate pivotally attached to one of the ends of the hook body, and engageable with the other end of the hook body, in order to enclose the mouth of the hook body.

For example, U.S. Pat. No. 5,664,304 to Tambornino, and U.S. Pat. No. 5,913,479 to Westwood, III, disclose two of the typical snap hooks each comprising a latch or gate pivotally attached to one end of the hook body to enclose the mouth of the hook body, and to prevent objects from entering into a hook opening of the hook body.

However, the latch or gate is simply attached to the hook body with a pivotal attachment, but may not be solidly secured or locked to the hook body, such that the latch or gate may have a good chance to be disengaged from the mouth of the hook body, or to have the mouth of the hook body opened inadvertently, by such as children, such that various objects may also have a good chance to enter into the hook opening of the hook body inadvertently.

The present invention has arisen to mitigate and/or obviate the afore-described disadvantages of the conventional snap hooks.

### SUMMARY OF THE INVENTION

The primary objective of the present invention is to provide a snap hook including a pivotal gate that may be locked to the snap hook and to be prevented from being opened inadvertently.

In accordance with one aspect of the invention, there is provided a snap hook comprising a hook member including a mouth formed between a securing end and a receiving end, a gate including a first end pivotally secured to the securing end of the hook member, to allow the gate to be rotated relative to the hook member, and to allow a second end of the gate to be rotated toward or away from the receiving end of the hook member, to enclose or to open the mouth of the hook member. A spring biasing member may be used to bias the gate to enclose the mouth of the hook member, and a latch may selectively lock the gate to the hook member, to prevent the second end of the gate from being rotated away from the receiving end of the hook member inadvertently.

The latch includes a catch extended therefrom to engage with the hook member, and to lock the gate to the hook member, and to prevent the gate from being rotated relative to the hook member. The hook member includes a lock notch formed therein, to receive the catch of the latch, and to lock the gate to the hook member. The lock notch of the hook member is preferably formed in the securing end of the hook member.

The gate includes means for forcing the catch of the latch to engage with the hook member. The gate includes a first finger extended therefrom, the latch includes a second finger extended therefrom, the forcing means includes a spring member engaged between the fingers of the gate and the latch.

The latch includes a flap extended therefrom, the second finger and the catch are extended from the flap of the latch. The gate includes an opening formed therein, the catch of the latch is extended through the opening of the gate. The gate includes a bar to define the opening thereof, the latch includes at least one extension extended therefrom, to engage with the bar of the gate, and to slidably retain the latch to the gate.

The receiving end of the hook member includes a recess formed therein, the second end of the gate includes a beam formed therein to selectively engage into the recess of the receiving end of the hook member. The hook member includes a protrusion extended from the receiving end thereof, to define the recess thereof, the second end of the gate includes a cavity formed therein to receive the protrusion of the hook member, and to position the second end of the gate to the hook member. The latch includes at least one swelling extended therefrom to facilitate moving of the latch relative to the gate.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a snap hook in accordance with the present invention;

FIG. 2 is a perspective view of the snap hook;

FIG. 3 is an enlarged perspective view showing a latch of the snap hook;

FIG. 4 is a cross sectional view of the snap hook, taken along lines 4-4 of FIG. 2;

FIG. 5 is a cross sectional view similar to FIG. 4, illustrating the operation of the snap hook;

FIGS. 6, 7 are exploded views similar to FIG. 1, illustrating the other arrangements or shapes of the snap hook;

FIG. 8 is a partial exploded view illustrating the other embodiment of the snap hook;

FIG. 9 is an enlarged perspective view showing the other structure of the latch of the snap hook;

FIG. 10 is an exploded views similar to FIGS. 1, 6, 7, illustrating the further structure of the latch of the snap hook; and

FIGS. 11, 12 are exploded views similar to FIGS. 1, 6, 7, 10, illustrating the further embodiments of the snap hook.

### DETAILED DESCRIPTION OF THE PREFERRED EMBODIMENT

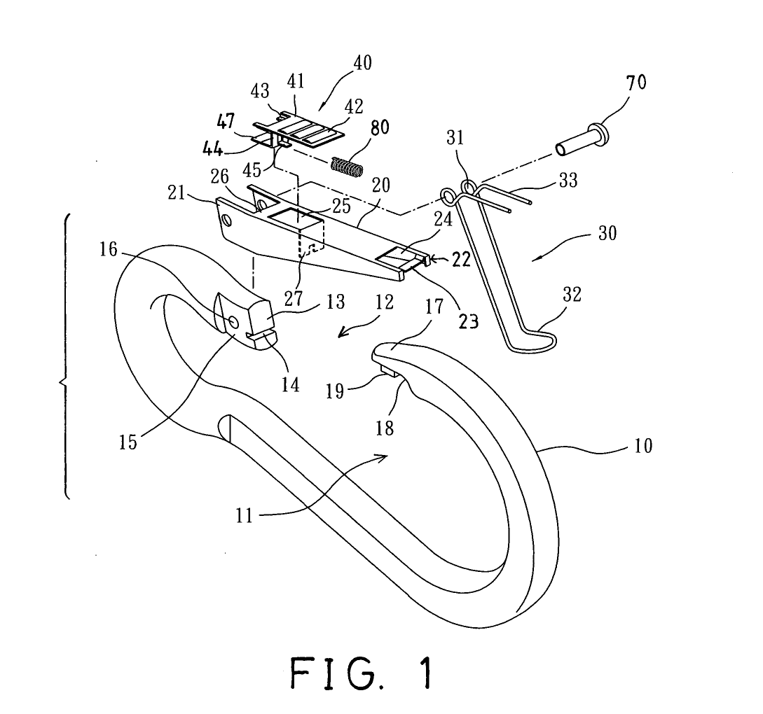

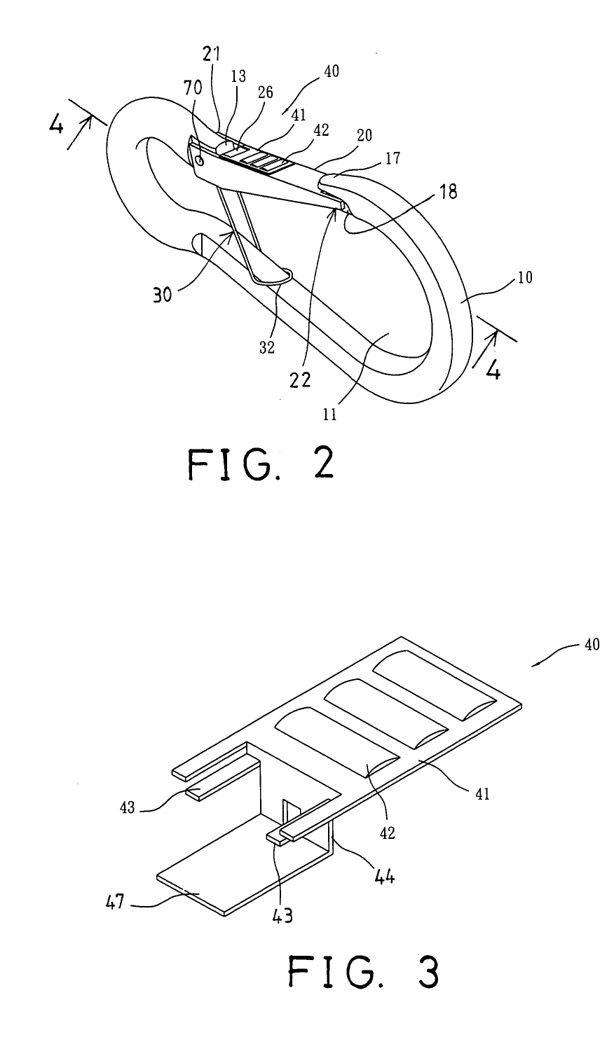

Referring to the drawings, and initially to FIGS. 1-4, a snap hook in accordance with the present invention comprises a hook link or hook member 10 made of or formed with a single round metal shank having a generally C-shaped structure. The C-shaped hook member 10 includes an opening 11 formed therein, and a mouth 12 formed or defined between two ends 13, 17, such as a securing end 13 and a receiving end 17.

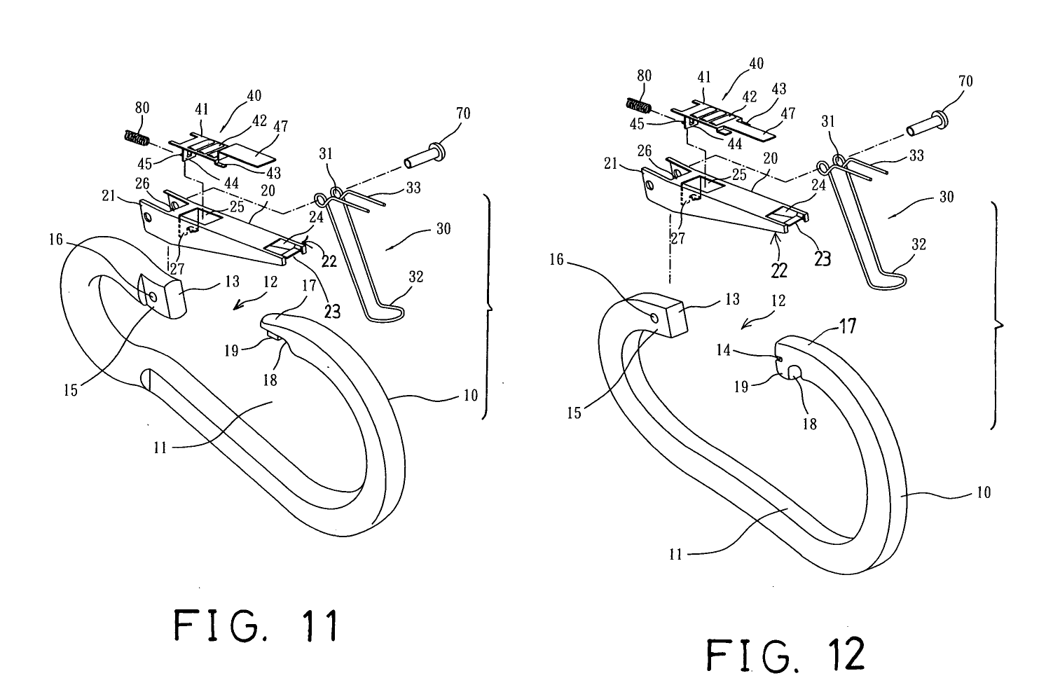

The hook member 10 includes a lock notch 14 formed in either the securing end 13 thereof (FIGS. 1 and 4-7) or the receiving end 17 thereof (FIG. 12). The securing end 13 of the hook member 10 is slightly tapered to form flattened side surfaces 15, and a hole 16 laterally formed through the securing end 13 of the hook member 10. The receiving end 17 of the hook member 10 includes a recess 18 formed therein and defined by a protrusion 19.

A gate 20 includes one end 21 engaged onto the securing end 13 of the hook member 10, and rotatably or pivotally secured to the securing end 13 of the hook member 10 with a pivot shaft 70, to allow the gate 20 to be rotated relative to the hook member 10, and to allow the other end 22 of the gate 20 to be rotated toward or away from the receiving end 17 of the hook member 10, to selectively enclose or open the mouth 12 of the hook member 10.

The gate 20 includes a cavity 24 formed in the other end 22 thereof to receive the protrusion 19 of the hook member 10, and to safely position the other end 22 of the gate 20 to the receiving end 17 of the hook member 10. The gate 20 includes an end beam 23 formed or provided in the other end 22 thereof, to form or define the cavity 24 thereof, and to engage onto the recess 18 of the receiving end 17 of the hook member 10.

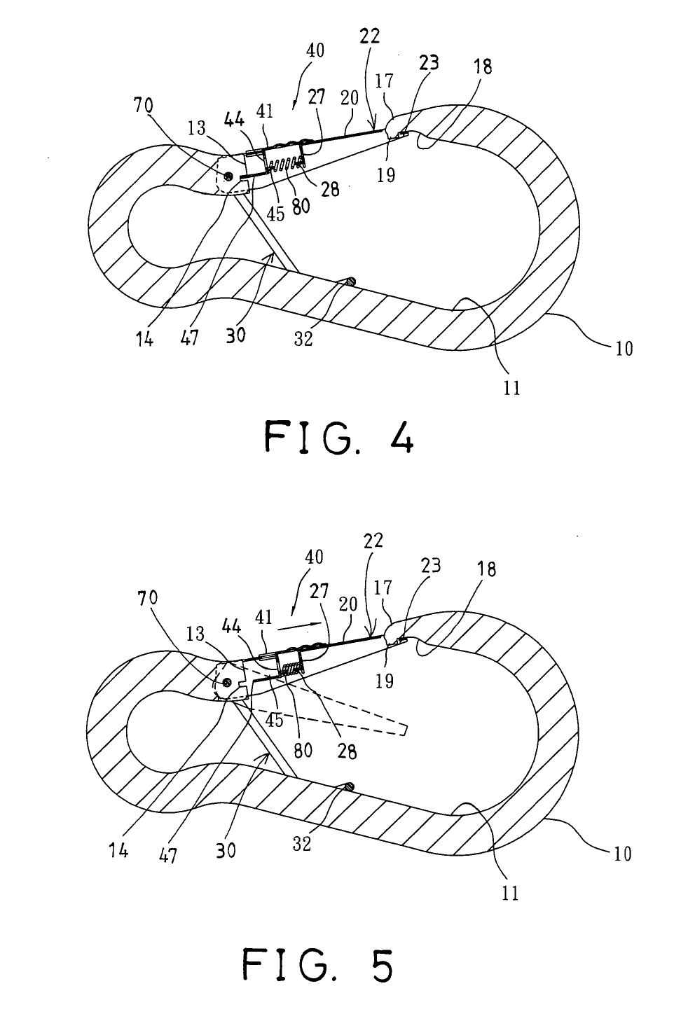

The gate 20 further includes an opening 25 formed in the middle or intermediate portion thereof, and defined between a bar 26 and a panel 27, in which the panel 27 is preferably located closer to the other end 22 of the gate 20, and includes a finger 28 extended therefrom (FIGS. 4, 5), such as extended toward the one end 21 of the gate 20, to engage with a spring member 80.

Another spring member 30 includes one or more rings 31 formed in the middle or intermediate portion thereof to receive the shaft 70, and includes two ends 32, 33 engaged with the hook member 10 and the gate 20 respectively, to bias the gate 20 against the hook member 10, and to force the protrusion 19 of the hook member 10 to engage onto the cavity 24 of the gate 20, and/or to force the end beam 23 of the gate 20 to engage onto the recess 18 of the hook member 10.

A latch 40 includes a plate 41 slidably engaged onto the gate 20, and includes one or more swellings 42 extended upwardly from the plate 41, to facilitate moving of the latch 40 relative or along the gate 20. The latch 40 includes one or more extensions 43 extended rearwardly therefrom and engageable with the bar 26 of the gate 20, to slidably retain the latch 40 to the gate 20, and to prevent the latch 40 from being disengaged from the gate 20.

The latch 40 further includes a flap 44 extended downwardly therefrom and extended through the opening 25 of the gate 20, and another finger 45 extended therefrom and also extended through the opening 25 of the gate 20, to engage with the spring member 80, and thus to stably retain the spring member 80 between the gate 20 and the latch 40. The latch 40 further includes a catch 47 extended rearwardly from the flap 44, and biased by the spring member 80 to engage into the lock notch 14 of the hook member 10, and thus to lock the gate 20 to the hook member 10.

In operation, as shown in FIG. 4, when the catch 47 of the latch 40 is biased by the spring member 80 to engage into the lock notch 14 of the hook member 10, the gate 20 may be locked to the hook member 10 and may be prevented from being rotated relative to the hook member 10, such that the other end 22 of the gate 20 may not be rotated away from the receiving end 17 of the hook member 10, and such that the mouth 12 of the hook member 10 may not be opened inadvertently.

As shown in FIG. 5, when the latch 40 is moved away from the securing end 13 of the hook member 10, the catch 47 of the latch 40 may be disengaged from the lock notch 14 of the hook member 10 against the spring member 80, and the gate 20 may be unlocked from the hook member 10 and may be rotated relative to the hook member 10, to allow the other end 22 of the gate 20 to be rotated away from the receiving end 17 of the hook member 10, and thus to open the mouth 12 of the hook member 10, as shown in dotted lines in FIG. 5.

Accordingly, the mouth 12 of the hook member 10 may only be opened when the latch 40 is moved away from the securing end 13 of the hook member 10 and when the catch 47 of the latch 40 is disengaged from the lock notch 14 of the hook member 10 against the spring member 80, such that the mouth 12 of the hook member 10 may not be opened inadvertently by such as children, or by hitting or striking against the hook member 10.

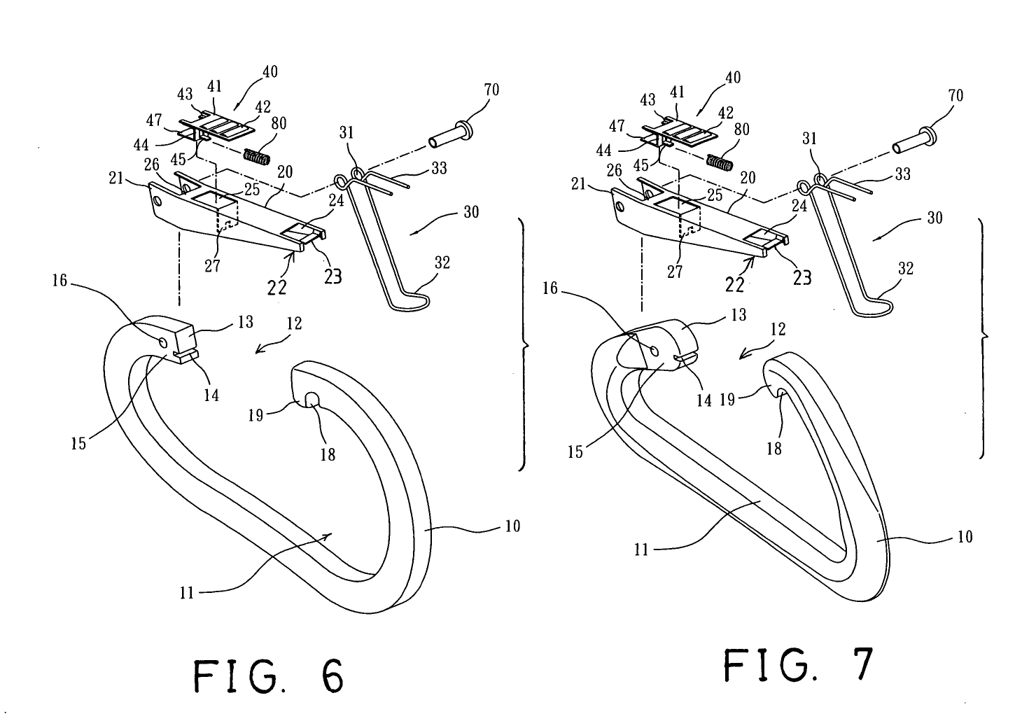

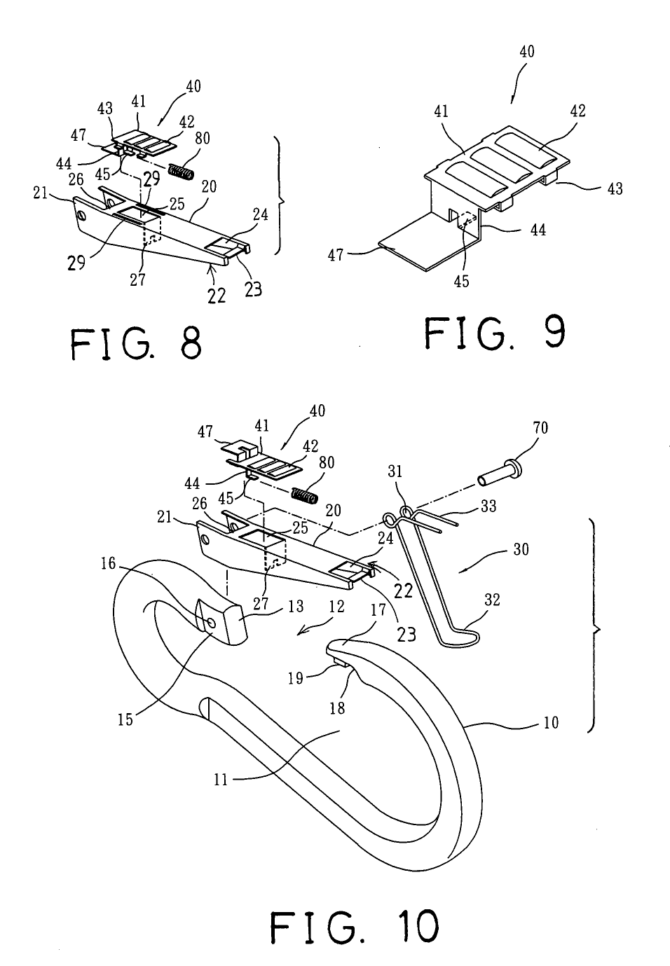

As shown in FIGS. 6 and 7, the hook member 10 may be formed into various kinds of shapes. As shown in FIGS. 8 and 9, the gate 20 may include one or more, such as two channels 29 formed beside the opening 25 thereof, and the latch 40 may include one or more spring legs 43 extended therefrom, to slidably engage into the channels 29 of the gate 20, and to slidably attach the latch 40 to the gate 20.

As shown in FIG. 10, the catch 47 of the latch 40 may be extended above the latch 40, instead of below the latch 40 (FIGS. 1, 4-9), for directly engaging onto the securing end 13 of the hook member 10, without the formation or provision of the lock notch 14 in the hook member 10.

Further alternatively, as shown in FIGS. 11 and 12, the catch 47 of the latch 40 may also be extended forwardly from the latch 40, to either engage into the lock notch 14 formed in the receiving end 17 of the hook member 10 (FIG. 12), or to directly engage onto the receiving end 17 of the hook member 10 (FIG. 11), without the formation or provision of the lock notch 14 in the hook member 10.

Accordingly, the snap hook in accordance with the present invention includes a pivotal gate that may be locked to the snap hook and to be prevented from being opened inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A snap hook comprising:
a hook member including a mouth formed between a securing end and a receiving end,
a gate including a first end pivotally secured to said securing end of said hook member, to allow said gate to be rotated relative to said hook member, and to allow a second end of said gate to be rotated toward or away from said receiving end of said hook member, to enclose or to open said mouth of said hook member, said gate including an opening formed therein, and including a bar to define said opening thereof,
means for biasing said gate to enclose said mouth of said hook member, and
a latch selectively locking said gate to said hook member, to prevent said second end of said gate from being rotated away from said receiving end of said hook member inadvertently, said latch including a catch extended therefrom to engage with said hook member, and to lock said gate to said hook member, and to prevent said gate from being rotated relative to said hook member, said catch of said latch being extended through said opening of said gate, said latch including at least one extension extended therefrom, to engage with said bar of said gate, and to slidably retain said latch to said gate.

2. (canceled)

3. The snap hook as claimed in claim 1, wherein said hook member includes a lock notch formed therein, to receive said catch of said latch, and to lock said gate to said hook member.

4. The snap hook as claimed in claim 3, wherein said lock notch of said hook member is formed in said securing end of said hook member.

5. The snap hook as claimed in claim 1, wherein said gate includes means for forcing said catch of said latch to engage with said hook member.

6. A snap hook comprising:
a hook member including a mouth formed between a securing end and a receiving end
a gate including a first end pivotally secured to said securing end of said hook member, to allow said gate to be rotated relative to said hook member, and to allow a second end of said gate to be rotated toward or away from said receiving end of said hook member, to enclose or to open said mouth of said hook member, said gate including a first finger extended therefrom,
means for biasing said gate to enclose said mouth of said hook member,
a latch selectively locking said gate to said hook member, to prevent said second end of said gate from being rotated away from said receiving end of said hook member inadvertently, said latch including a catch extended therefrom to engage with said hook member, and to lock said gate to said hook member, and to prevent said gate from being rotated relative to said hook member, said latch including a second finger extended therefrom, and
means for forcing said catch of said latch to engage with said hook member, said forcing means including a spring engaged between said fingers of said gate and said latch.

7. The snap hook as claimed in claim 6, wherein said latch includes a flap extended therefrom, said second finger and said catch are extended from said flap of said latch.

8-9. (canceled)

10. The snap hook as claimed in claim 1, wherein said receiving end of said hook member includes a recess formed therein, said second end of said gate includes a beam formed therein to selectively engage into said recess of said receiving end of said hook member.

11. The snap hook as claimed in claim 10, wherein said hook member includes a protrusion extended from said receiving end thereof, to define said recess thereof, said second end of said gate includes a cavity formed therein to receive said protrusion, and to position said second end of said gate to said hook member.

12. The snap hook as claimed in claim 1, wherein said latch includes at least one swelling extended therefrom to facilitate moving of said latch relative to said gate.
